(19) United States
(12) Patent Application Publication
(10) Pub. No.: US 2024/0402658 A1
(43) Pub. Date: Dec. 5, 2024

(54) BUILDING AUTOMATION SYSTEM WITH PIPING GRAPHIC CONTROL

(71) Applicant: Siemens Schweiz AG, Zürich (CH)

(72) Inventors: James Han, Long Grove, IL (US); Vikraman Kesavan, Buffalo Grove, IL (US); Elena Pokatayev, Volo, IL (US); Megan Stolz, Chicago, IL (US); Ceylan D. Nashashibi, Evanston, IL (US)

(73) Assignee: Siemens Schweiz AG, Zürich (CH)

(21) Appl. No.: 18/694,828

(22) PCT Filed: Nov. 10, 2021
(86) PCT No.: PCT/US2021/058688

§ 371 Date: Mar. 22, 2024

Related U.S. Application Data
(60) Provisional application No. 63/273,573, filed on Oct. 29, 2021.

(51) Int. Cl. G05B 13/02

(52) U.S. Cl. CPC G05B 13/021

(57) ABSTRACT

There is described building automation systems, methods, and computer readable media for piping graphic control. Field devices associated with HVAC equipment are identified and an HVAC piping graphic associated with the field devices are generated at the management device. The HVAC piping graphic is modified at a processor of the management device in response to receiving user input at a user interface of the management device. In particular, a pipe element and a pipe coupling element are integrated with the HVAC piping graphic based on the user input. Data points of the building automation system are provided at the user interface based on the pipe element and the pipe coupling element. Runtime values are monitored, and the building automation system (100) are dynamically controlled at the management device based on the data points.

### FIELD OF THE INVENTION

This application relates to the field of building management tools and, more particularly, to a piping graphic system supporting a building automation system.

### BACKGROUND

Building automation systems encompass a wide variety of systems that aid in the monitoring and control of various aspects of building operation. The systems typically have one or more centralized control stations operating management software so that data from the system may be monitored and field devices may be controlled by stations. The systems may include one or more subsystems, such as security, fire safety, lighting, and heating, ventilation, and air conditioning (“HVAC”) units.

A control station may include a graphic editor application to allow users to create large graphical representations of equipment, floors, buildings, facilities, and entire campuses. These graphic representations may include dynamic elements to represent devices or value to monitor and control. For example, a graphic designer may be asked to create HVAC duct or piping diagrams of a facility or to replicate a piping wireframe or blueprint with devices. The control station may utilize such diagrams in conjunction with other building management tools to monitor and control the facility. The tasks are time-consuming and require skills to create graphic objects on the graphical user interface (“GUI”) canvas of the graphic editor, particularly to mimic a piping system of a building automation system.

Conventional graphic editors provide primitive graphic elements, such rudimentary lines or path elements. Graphic designers must draw and format these elements to resemble pipes and manually combine their created graphic elements to create a piping system. Convention graphic editors do not provide an easy way to manipulate these elements in a way that is conducive to engineering, for replicating a pipe, or for tracing over a piping blueprint imported into the system. For these reasons, the process of creating a piping element with line or path elements is time- consuming and tedious, requiring a significant skill to manipulate and combine many of rudimentary elements to build a piping graphic and mimic a piping system on the canvas of the graphic editor.

### SUMMARY

In accordance with one embodiment of the disclosure, there is provided a piping graphic editing approach for building automation systems. In particular, a piping graphic editor facilitates a process of engineering and replicating one or more pipes or manipulating imported piping elements. The piping graphic editor allows for the creation of a piping graphic to mimic an HVAC piping network faster and easier than conventional editors by minimizing the need to tediously build pipe diagrams using rudimentary line and path elements. Accordingly, the time needed to produce a graphic representation of a piping system is reduced or minimized.

One aspect is a system with piping graphic control for building automation comprising a field device of the building automation and a management device communicating with multiple field devices associated with multiple HVAC equipment including the field device of the building automation. The field device manages an HVAC device of an environmental system. The management device comprises a user interface and a processor. The user interface receives a user input and provide data points of the building automation system based on a pipe element and a pipe coupling element. The processor identifies the field devices, generates an HVAC piping graphic associated with the field devices, modifies the HVAC piping graphic based on the user input by integrating a pipe element and a pipe coupling element coupled to the pipe element with the HVAC piping graphic based on the user input. The management device monitors runtime values and dynamically controls the building automation system based on the data points of the building automation system.

Another aspect is a method for a building automation system with piping graphic control. Multiple field devices associated with multiple HVAC equipment corresponding to the field devices are identified at a management device of the building automation system. An HVAC piping graphic associated with the field devices is generated at the management device. A user input is received at a user interface of the management device. The HVAC piping graphic is modified at a processor of the management device in response to receiving the user input. Modifying the HVAC piping graphic including integrating a pipe element and a pipe coupling element coupled to the pipe element with the HVAC piping graphic based on the user input. Data points of the building automation system are provided at the user interface based on the pipe element and the pipe coupling element. Runtime values are monitored, and the building automation system are dynamically controlled at the management device based on the data points of the building automation system.

Yet another aspect is a non-transitory computer readable medium including executable instructions which, when executed, causes at least one processor to provide piping graphic control for a building automation system by performing the method above.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is a schematic view illustrating a building automation system (“BAS”) in an example implementation that is operable to employ techniques described herein.

FIG. 2 is a block diagram depicting an example implementation of a management device, such as those shown with the BAS of FIG. 1.

FIG. 3 depicts an example visual depiction of a heating, ventilation, and air conditioning (HVAC) unit that may be managed by the BAS of FIG. 1.

FIG. 4A is a partial view of an example visual depiction of an HVAC piping diagram as shown at a user interface of the management device.

FIG. 4B is a partial view of another example visual depiction of an HVAC piping diagram and an associated properties shown at the user interface of the management device.

FIG. 5 is a table representing example element handles of the visual depiction of an HVAC piping diagram.

FIG. 6 is a flow diagram representing an operation of the BAS in an example implementation that is operable to employ techniques described herein.

FIG. 7 is a flow diagram representing an operation of a piping graphic editor or module in an example implementation that is operable to employ the techniques described herein.

### DETAILED DESCRIPTION

Various technologies that pertain to systems and methods that facilitate creating and editing of piping graphic representations of a building automation system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

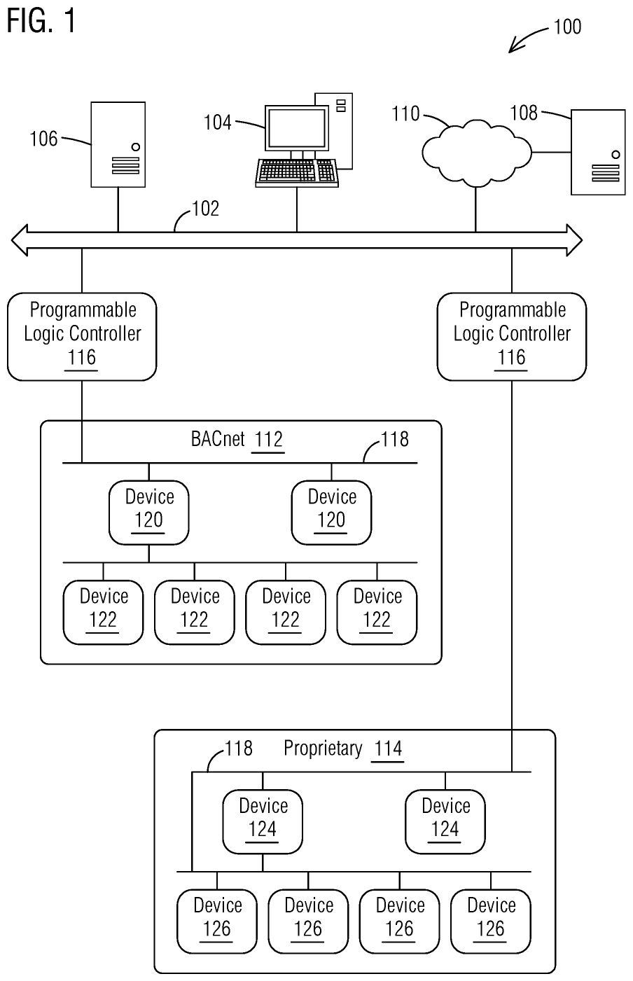

Referring to FIG. 1, there is shown a building automation system (“BAS”) 100 in an example implementation that is operable to employ techniques described herein. The BAS 100 includes an environmental control system configured to control one or more environmental parameters for a facility, such as fluid flow, fluid pressure, fluid temperature, and the like. For example, the BAS 100 may comprise one or more network connections or primary buses 102 for connectivity to components of a management level network (“MLN”) of the system. For one embodiment, the example BAS 100 may comprise one or more management devices, such as a management workstation 104, a management server 106, or a remote management device 108 connecting through a wired or wireless network 110, that allows the setting and/or changing of various controls of the system. A management device may also be a portable management device connecting through a wired or wireless link to an individual field device that allows the setting and/or changing of various controls of the field device. While a brief description of the BAS 100 is provided below, it will be understood that the BAS 100 described herein is only one example of a particular form or configuration for a BAS. The system 100 may be implemented in any other suitable manner without departing from the scope of this disclosure. The management devices are configured to provide overall control and monitoring of a field device, a group of field devices, or the BAS 100.

For the illustrated embodiment of FIG. 1, the BAS 100 provides connectivity based on one or more communication protocols to subsystems for various environmental parameters such as components of environmental comfort systems. For some embodiments, a subsystem 112 may provide connectivity based on a BACnet communication protocol. For some embodiments, a subsystem 114 may provide connectivity based on a proprietary communication protocol. Each subsystem 112, 114 may include various field devices 120, 122, 124, 126 for monitoring and controlling areas within a building or group of buildings. For field devices that monitor and control fluid heating-cooling HVAC equipment, the field devices may include, but are not limited to, stations, actuators, sensors, panels, and other types of controllers for the HVAC equipment, such as fluid heating/cooling generators, pumps, compressors, condensers, evaporators, tanks/reservoirs, filters, valves, bypass mechanisms, and the like.

For some embodiments, the BAS 100 may include one or more programmable logic controllers 116 for connectivity to components of a building level network (BLN) of the system 100. Each programmable logic controller 116 may connect the primary bus 102 of the MLN to a secondary bus 118 of the BLN. Each programmable logic controller 116 may also include management logic for switching, power quality, and distribution control for the BLN components. Some field devices 120, 124 may communicate directly with the network connection or secondary bus 118 of the BLN, whereas other field devices 122, 126 may communicate through, and perhaps be controlled by, another field device (such as device 120, 124).

In these illustrative embodiments, objects associated with the BAS 100 include anything that creates, processes, or stores information regarding data points, such as field devices (controllers, field panels, sensors, actuators, cameras, etc.) and maintains data files, such as control schedules, trend reports, defined system hierarchies, and the like. The illustration of the BAS 100 in FIG. 1 is not meant to imply physical or architectural limitations to the manner in which different illustrative embodiments may be implemented. Other components in addition to and/or in place of the ones illustrated may be used, and some components may be unnecessary in some illustrative embodiments.

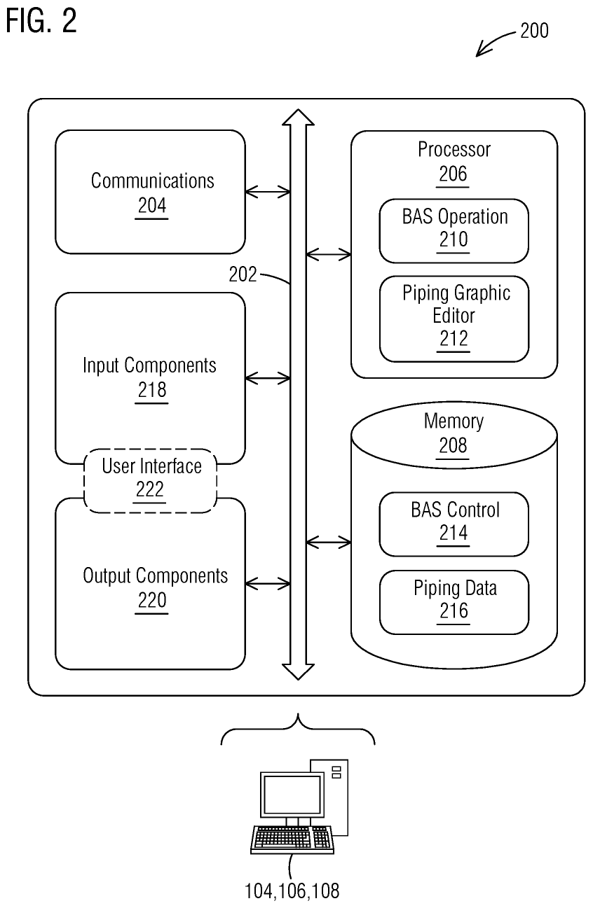

FIG. 2 represents example device components 200 of a management device. such as the management workstation 104, management server 106, and/or remote management device 108, for the setting and/or changing of various controls of the field device. Accordingly, FIG. 2 is an example representation of each device, i.e., the management device 104-108, or a combination of these devices. The device components 200 comprise a communication bus 202 for interconnecting other device components directly or indirectly. The other device components include one or more communication components 204 communicating with other entities via a wired or wireless network, one or more processors 206, and one or more memory components 208.

The communication component 204 is configured to receive data associated with one or more points of a site from a corresponding field device of the BAS 100 and otherwise manage the field device. For example, the communication component 204 may receive data from field devices of the subsystems 112, 114. The communication component 204 may utilize wired technology for communication. such as transmission of data over a physical conduit, e.g., an electrical or optical fiber medium. For some embodiments, the communication component 204 may also utilize wireless technology for communication, such as radio frequency (RF), infrared, microwave, light wave, and acoustic communications. RF communications include, but are not limited to, Bluetooth (including BLE), ultrawide band (UWB), Wi-Fi (including Wi-Fi Direct), Zigbee, cellular, satellite, mesh networks, PAN, WPAN, WAN, near-field communications, and other types of radio communications and their variants.

The processor or processors 206 may execute code and process data received from other components of the device components 200, such as information received at the communication component 204 or stored at the memory component 208. The code associated with the BAS 100 and stored by the memory component 208 may include, but is not limited to, operating systems, applications, modules, drivers, and the like. An operating system includes executable code that controls basic functions, such as interactions among the various components of the device components 200, communication with external devices via the communication component 204, and storage and retrieval of code and data to and from the memory component 208.

Each application includes executable code to provide specific functionality for the processor 206 and/or remaining components of the management and/or field device 104-108, 120-126. Examples of applications executable by the processor 206 include, but are not limited to, a building automation system (“BAS”) operation module 210 and a piping graphic editor or module 212. The BAS operation module 210 controls and manages the performance of the BAS for monitoring and controlling a building's mechanical and electrical equipment, including at least one of heating, cooling, circulating, lighting, security, fire devices, and the like. The piping graphic editor or module 212 generates and manipulates pipe elements and pipe coupling elements that interconnect the various HVAC equipment of the environmental system.

Data stored at the memory component 208 is information that may be referenced and/or manipulated by an operating system or application for performing functions of the management and/or field device 104-108, 120-126, 201. Examples of data associated with the BAS 100 and stored by the memory component 208 may include, but are not limited to, BAS control data 214 and piping graphic editor data (“piping data”) 216. The BAS control data 214 includes information needed or desired to control and manage the performance of the BAS. The piping data 216 includes graphical representations and/or metadata associated with pipe elements, pipe coupling elements, and other devices and components of the HVAC equipment of the environmental system.

The device components 200 may include one or more input components 218 and one or more output components 220. The input components 218 and output components 220 of the device components 200 may include one or more visual, audio, mechanical, and/or other components. For some embodiments, the input and output components 218, 220 may include a user interface 222 for interaction with a user of the device. The user interface 222 may include a combination of hardware and software to provide a user with a desired user experience.

It is to be understood that FIG. 2 is provided for illustrative purposes only to represent examples of the device components 200 of the management and/or field device 104-108, 120-126 and is not intended to be a complete diagram of the various components that may be utilized by the system. Therefore, the management and/or field device 104-108, 120-126 may include various other components not shown in FIG. 2, may include a combination of two or more components, or a division of a particular component into two or more separate components, and still be within the scope of the present invention.

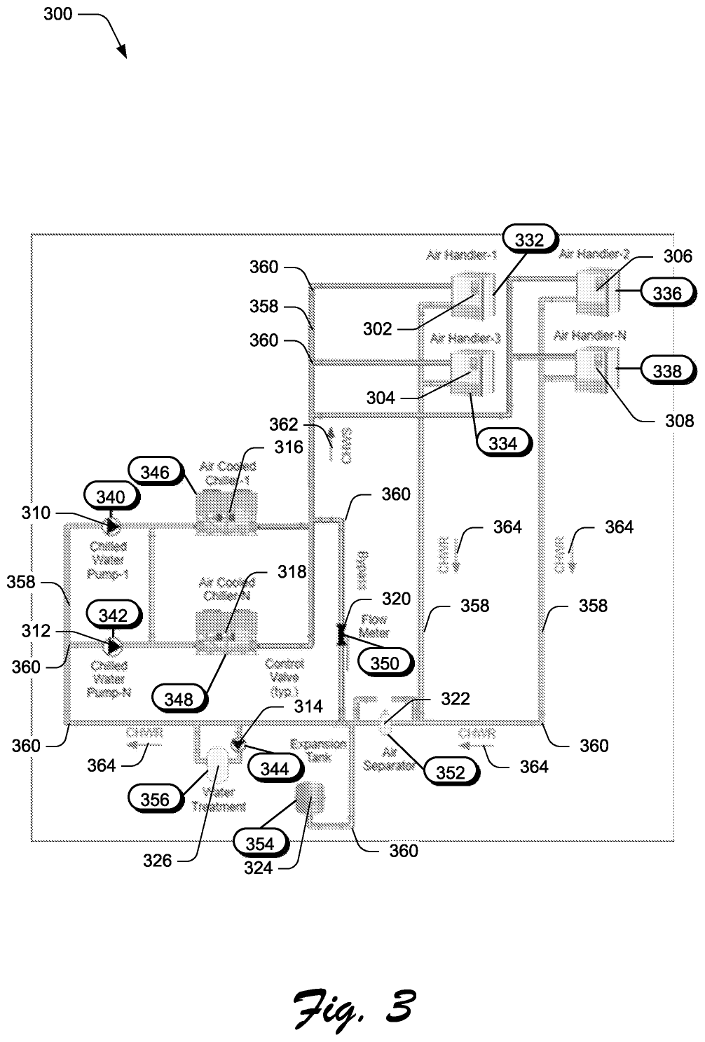

FIG. 3 illustrates an example visual depiction 300 of an environmental system in accordance with disclosed embodiments, in particular for this example a fluid handling unit. Piping systems created by pipe and pipe coupling elements may be associated to device/equipment symbols corresponding to equipment, pumps, or other building devices of the HVAC system that have corresponding device objects for controlling/monitoring the respective building devices. Examples of HVAC equipment for an environmental system include, but are not limited to, air handlers 302-308, pumps 310-314, chillers 316-318, and flow meters 320. Each environmental system, or other devices described above in the BAS 100, includes one or more field devices, such as a sensor 304, actuator 306, and/or other types of controllers 308. Some embodiments may include other examples of HVAC equipment for the environmental system, such as air separators 322, expansion tanks 324, and water treatment equipment 326. Each HVAC equipment 302-326 may have one or more associated field device 332-356 or other controller to control, monitor, or otherwise interact with the HVAC equipment. Examples of the field devices 332-356 may include, but are not limited to, stations, actuators, sensors, panels, and other types of controllers having a function associated with temperature, pressure, flow, and/or other characteristics for the HVAC equipment 302-326.

One or more management devices 104-108 of the building automation system 100 may manage the environmental system by, in part, generating a visual depiction 300 of the environmental system, such that the one illustrated by FIG. 3. In particular the management device 104-108 may include a piping graphic editor 212 to generate and manipulate pipe elements and pipe coupling elements that interconnect the various HVAC equipment of the environmental system. For example, the piping graphic editor 212 may facilitate the creation and adjustment of pipe elements and pipe coupling elements, with or without bends, to produce the visual depiction 300. The piping graphic editor 212 may include user interface features for using pipe elements and couple element features/properties to manipulate (i.e., an expansion of use of “handle” properties) and build a piping network graphic interface for a BAS.

As stated above, the piping graphic editor 212 provides, among other elements, the pipe element 358 and the pipe coupling element 360. As shown in FIG. 3, the pipe elements 358 and pipe coupling elements 360 may be used to represent and manage chilled water supply 362 from chillers 316-318 to air handlers 302-308 of the HVAC equipment as well as other equipment such as the flow meter 320. Likewise, the pipe elements 358 and pipe coupling elements 360 may be used to represent and manage chilled water returns 364 from the air handlers 302-308 of the HVAC equipment back to the chillers 316-318 as well as other equipment such as the pumps 310-314, separators 322, storage equipment 324, and treatment equipment 326. It should be noted that, in FIG. 3, select pipe elements 358 and pipe coupling elements 360 are labeled by example and not all elements are labeled. The piping graphic editor 212 uses the pipe element 358 and pipe coupling element 360 to build a customized HVAC piping graphic easily and quickly with corresponding pipe and pipe couplings. In particular, the piping graphic editor 212 provides for integration with HVAC device graphics to allow for viewing data points of the HVAC system via properties of the pipe elements 358 and pipe coupling elements 360 as further described herein. The piping graphic editor 212 also enables placement of device/equipment symbols representing the HVAC devices on the piping graphic to monitor runtime values and dynamically control the system.

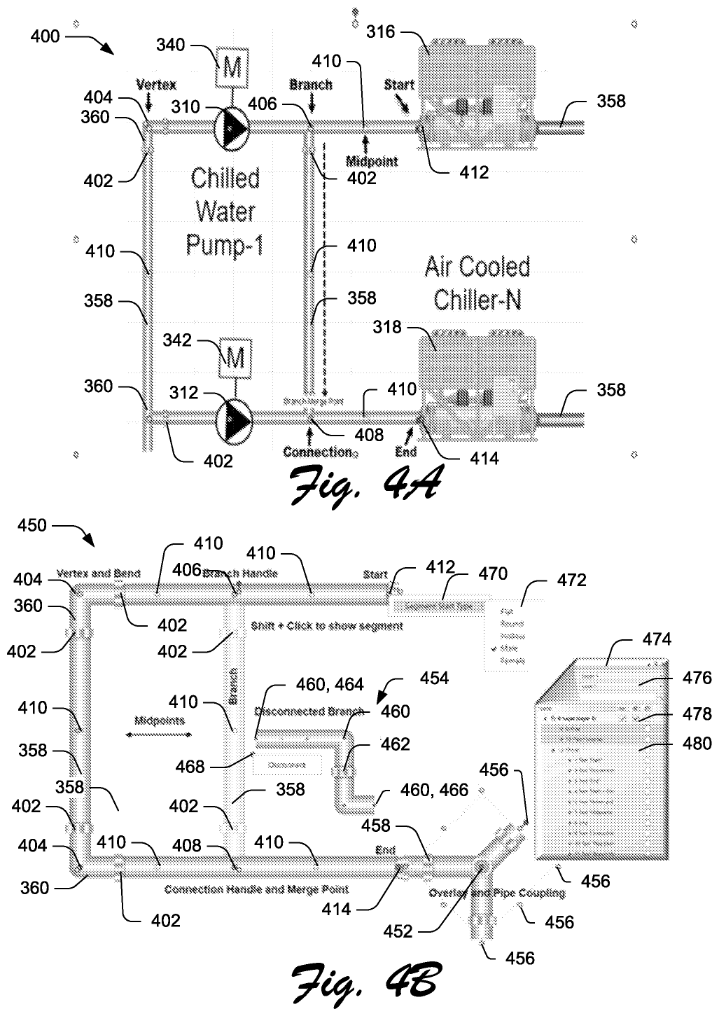

FIG. 4A is a partial view of an example visual depiction 400 of an HVAC piping diagram as shown at a user interface 222 of the management device 104, 106, 108. As shown in the greater view of FIG. 3, the visual depiction of the HVAC piping diagram includes various devices and equipment, such as pumps 310, 312, chillers 316, 318, field devices 340, 342, pipe elements 358, and pipe coupling elements 360. Pipe elements 358 and pipe coupling elements 360 may be coupled by a connection 402. The visual depiction 400 also includes various types of characteristics of the pipe elements 358 and the pipe coupling element 360. For example, each pipe or pipe coupling may have a vertex 404 point that marks the center of a bend in a pipe element and allows for the direction of the angle of the bend to be changed. Also, a branch handle 406 marks the beginning of a pipe element branch in a pipe, and a connection handle 408 marks the point where two pipe segments are merged. Further, a midpoint handle 410 marks the center of two pipe elements or segments and allows for the creation of a new branch. The ends of a pipe element or segment may be identified by a start handle 412 and an end handle 414.

FIG. 4B is a partial view of another example visual depiction 450 of an HVAC piping diagram and an associated properties shown at the user interface 222 of the management device 104, 106, 108. Similar to FIG. 4A, the visual depiction 450 of the HVAC piping diagram includes various devices and equipment, such as pipe elements 358, and pipe coupling elements 360. The visual depiction 400 also includes various types of characteristics of the pipe elements 358 and the pipe coupling element 360, such as connection 402, vertex 404 point, branch handle 406, connection handle 408, midpoint handle 410, start handle 412, and end handle 414. The visual depiction includes further types of characteristics such as an overlay and pipe coupling 452 and disconnected pipe elements 454. For the overlay and pipe coupling 452, a pipe coupling element may overlay a pipe element and vice-versa, in which the overlay and pipe coupling may include handles 456 for adjustment and manipulation of the overlay as well as one or more connections 458 to other pipe elements 358 and pipe coupling elements 360. The disconnected pipe elements 454 include handles 460 for adjustment and manipulation of the disconnected group for elements even though the elements are not connected to other pipe elements 358 and pipe coupling elements 360, s well as one or more connections 462 internal to the disconnect pipe elements. Being disconnected from other elements, the handles 460 of the disconnected pipe elements may include a disconnected start handle 464 and a disconnected end handle 466. In addition, disconnected pipe elements 454 may further include a disconnected branch handle 468 to manage a connect or disconnect status of the group of elements.

The user interface 222 of the management device 104, 106, 108 may operate in conjunction with the piping graphic editor or module 212 to provide handle properties 470, and for some embodiments subproperties 472, associated with a particular handle. For example, a user selection at the user interface 222 of the start handle or the end handle may display a start or end handle window 470 identifying properties 470 of the start/end handle, such as Segment Start Type. Likewise, selection of the property 470 may result in the appearance of a subwindow identifying subproperties of the start/end handle for the ends of a pipe segment, such as Flat, Round, Hollow, Male, and Female. Selection of a handle includes hovering a pointer over a pipe element handle such that, after a predetermined time period, a tooltip may pop-up showing shortcut properties of the corresponding handle.

In addition to the handles, the pipe elements 358 and the pipe coupling elements 360 may have properties 474 as well. Selection of a pipe element 358, a pipe coupling element 360, or an associated part of piping graphic menu may provide access to a properties window 476 that includes layer and group properties 478, 480 of the corresponding pipe element or pipe coupling element. The layer properties 478 may include information about pipe and pipe coupling subproperties associated with the corresponding application layer, and the group properties 480 may include information about various subproperties of the corresponding group of elements. For some embodiments, the properties of the pipe elements 358 and pipe coupling elements 360 may include fitting type property, which allows the user to identify the type of elbow bend for a pipe element to mimic piping of the HVAC system. For some embodiments, the properties may include an Auto Pipe Joint property to enable an auto display of a pipe joint on a pipe segment or on a pipe coupling element. For some embodiments, the properties may include a diameter property to allow entry of a value for a pipe diameter of a corresponding pipe element or pipe coupling element.

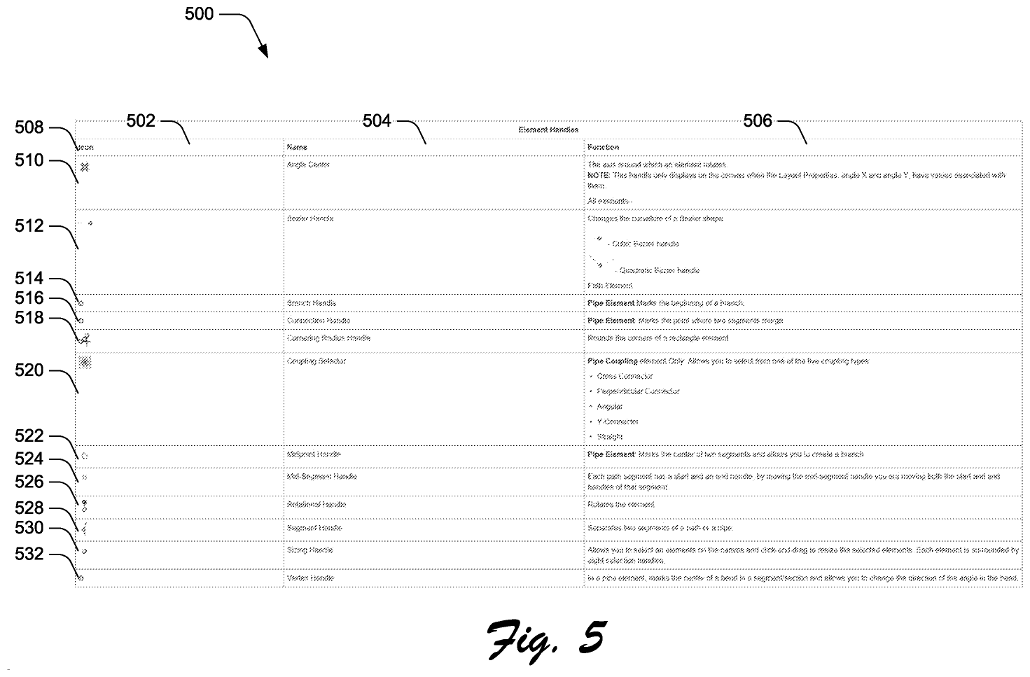

FIG. 5 is a table 500 representing example element handles of the visual depiction of an HVAC piping diagram. Each pipe element includes one or more element handles selectable at the user interface 222. The table 500 includes data correlating icons 502, identifiers 504, and/or characteristics 506 associated with element handles of the HVAC piping diagram. Part or all data of the table 500 may be stored at a memory component 208 of the management device 104, 106, 108. Some embodiments may include a header 508 for the table 500 of element handles. Each table 500 includes data associated with one or more element handles.

Examples of element handles include, but are not limited to, angle center 510, Bezier handle 512, branch handle 514, connection handle 516, cornering radius handle 518, coupling selector 520, midpoint handle 522, mid-segment handle 524, rotational handle 526, segment handle 528, sizing handle 530, and vertex handle 532. The angle center 510 marks the axis around which an element rotates. The Bezier handle 512 enables changes to a curvature of a Bezier shape of the corresponding element. The branch handle 514 marks the beginning of a pipe element branch in the pipe. The connection handle 516 marks the point where two pipe segments are merged. The cornering radius handle 518 enables corners of a rectangular element to be rounded. The coupling selector 520, which is specific to the pipe coupling elements, enables section of a coupling type, such as cross connector, perpendicular connector, angular connector, Y-connector, and straight connector. The positions may be further manipulated by using the existing element rotational handles or layout flip X and flip Y properties. The midpoint handle 522 marks the center of two pipe segments and allows the user to create a new branch. The mid-segment handle 524 may be selectively moved to cause the start and end handles of the respective pipe segment to move accordingly. The rotational handle 526 enables rotation of the corresponding element. The segment handle 528 enables separation of a path or a pipe. The sizing handle 530 enable selection and size modification of a corresponding element on the canvas. For the vertex handle 532, each pipe segment includes a vertex point that marks the center of a bend in a pipe segment and allows the direction of the angle of the bend to be changed. Each pipe element, pipe coupling element, group element, or other element of the HVAC piping graphic may include multiple sizing handles about a periphery of the element. For example, an overlay and piping coupling (such as the overlay 452 shown in FIG. 4B) may include eight sizing handles surrounding it. Collectively, multiple handles may allow pipe elements and pipe coupling elements to extend with no bend, extend with a restricted angle, merge, slide, move, and disconnect from other elements.

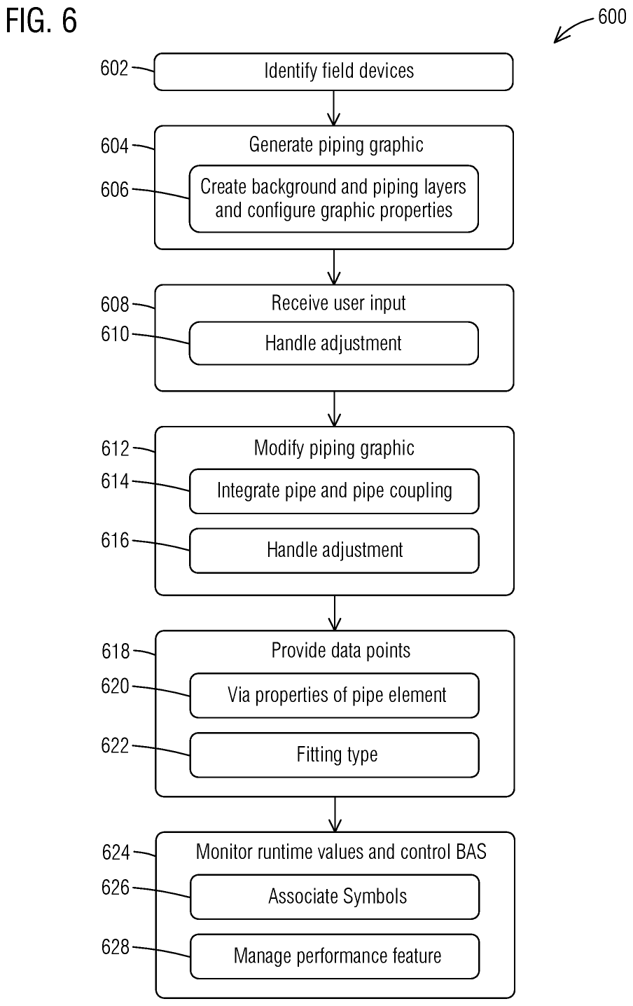

FIG. 6 is a flow diagram representing an operation 600 of the BAS in an example implementation that is operable to employ techniques described herein. In particular, the operation 600 represents, by example, a method for a building automation system with piping graphic control. The management device 104, 106, 108 of the BAS may identify field devices associated with HVAC equipment corresponding to the field devices (602). After identifying the field devices (602), the management device 104, 106, 108 may generate an HVAC piping graphic associated with the field devices (604). For some embodiments, in generating the HVAC piping graphic (604), the management device 104, 106, 108 may create a background layer to guide pipe drawings, create a piping layer that distinguishes hot water pipe elements from cold water pipe elements, and configuring graphic properties of a canvas for the HVAC piping graphic (606).

After generating the HVAC piping graphic (604), the management device 104, 106, 108 may receive a user input at the user interface 222 of the management device (608). Each pipe element includes multiple handles and, for some embodiments, the user input received at the user interface includes an adjustment of one or more handles (610).

In response to receiving the user input (608), the processor 206 of the management device 104, 106, 108 modifies the HVAC piping graphic (612). For some embodiments, the processor 206 may integrate a pipe element and a pipe coupling element coupled to the pipe element with the HVAC piping graphic based on the user input (614). Also, each pipe element includes multiple handles and, for some embodiments, the processor 206 modifies the HVAC piping graphic based on the adjustment of one or more handles (616).

After modifying the HVAC piping graphic (612), the user interface 222 of the management device 104, 106, 108 provides data points of the building automation system based on the pipe element and the pipe coupling element (618). For some embodiments, the user interface 222 provides the data points of the building automation system via properties of the pipe element and the pipe coupling element (620). For some embodiments, the properties of the pipe element and the pipe coupling element may include a fitting type to identify a type of elbow bend for a pipe element and an auto pipe joint property to automatically provide a pipe joint on the pipe element (622).

After providing the data points (618), the management device 104, 106, 108 may monitor runtime values and dynamically control the building automation system based on the data points of the building automation system (624). For some embodiments, the management device 104, 106, 108 may associate device/equipment symbols representing the field devices on the HVAC piping graphic and monitor the runtime values and dynamically control the field devices based on the device/equipment symbols (626). For some embodiments, the management device 104, 106, 108 may manage one or more performance features of the field devices based on the HVAC piping graphic (628) as modified by the processor 206 of the management device 104, 106, 108 (612).

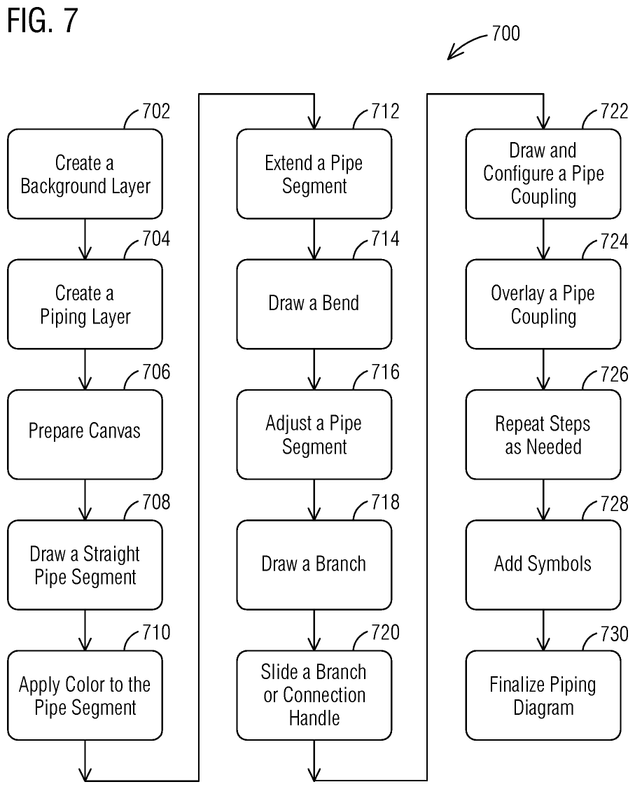

FIG. 7 is a flow diagram representing an operation 700 of a piping graphic editor or module of the management device 104, 106, 108 in an example implementation that is operable to employ the techniques described herein. The piping graphic editor may be used to draw pipe objects, such as pipe elements and/or the pipe coupling elements. There are a number of ways to plan and organize work and how to approach the diagram. The workflow shown in FIG. 8 is merely a suggested approach for the use of pipe and pipe coupling elements to create a piping diagram. The inclusion or order of the workflow parts may vary for each particular use case unless otherwise specified below. For some embodiments, the HVAC piping graphic may be provided on a single layer or subdivided on multiple layers that include one or more of the following: an imported wireframe or blueprint layer, pipe elements layer, symbols layer, and text layer. The pipe elements layer may include multiple pipe layers, such as one for hot water pipes and another for cold water pipes. Examples of symbols provided at the symbols layer include, but are not limited to, equipment, pipes, devices, and the like. Examples text provided at the text layer includes, but are not limited to, headers, labels for equipment, directional arrows, and the like.

The operation 700 of a piping graphic editor or module of the management device 104, 106, 108 is initiated by generating an HVAC piping graphic. In particular, a background layer is created (702) to guide pipe drawings, a piping layer is created (704), and graphic properties of a canvas for the HVAC piping graphic may be configured (706). The background layer may be created (702) to guide one or more pipe drawings. One or more pipe and symbol layers may be created for each pipe diagram (704). For some embodiments, a layer may include both hot and cold pipe elements, such as one for hot water and one for cold water. A hot and cold water pipe elements may be distinguished using visual characteristics, such as color, shading, transparency, compound type, dash type, and the like. The system may prepare a canvas for drawing pipes (706). Before creating an image, graphic, or symbol, a workspace may be prepared in the piping graphic editor. The canvas may include grid lines to position and work with the pipe elements. Examples of workspace properties include, but are not limited to, snap to grid, display grid, display guidelines, pitch (such as x, y, and pitch angle), offset (such as x, y, and offset angle), grid style (such as lines), enable 3D axis, and color (such as x, y, and z grid color properties). When a pipe diagram is complete, the layer's setting may be changed so that part or all of the background layer is not visible in Runtime mode.

The operation 700 of a piping graphic editor or module of the management device 104, 106, 108 continues by generating and modifying various components of the HVAC piping graphic. Although these generations and modifications are shown in FIG. 8 in a certain order, it is to be understood that these actions may occur in any order so long as elements are generated before being modified. The operation 700 may allow a pipe element, such as a pipe segment, to be manipulated at the canvas, in which a straight pipe segment may be drawn by selecting a pipe element (708). For example, a crosshairs cursor of the HVAC piping graphic may be clicked and dragged to draw a straight pipe segment. Each pipe segment may be associated with pipe segment properties. Examples of pipe segment properties include, but are not limited to, fitting type (such as round end or miter end), auto pipe joint (to automatically display the pipe joints as a segment is drawn), and pipe segment diameter.

A pipe element or segment of the HVAC piping graphic may be modified in multiple ways. For some embodiments, a linear gradient may be applied to the pipe segment, as well as a pipe coupling segment, to create a 3 dimensional appearance (710). A brush editor gradient stops of the system may be used to apply color to one or more 3D-appearing pipe segments. In particular, a particular color of a color palette may be assigned to first and last gradient stops of a pipe segment or pipe coupling segment and an intermediate gradient stop may be left unchanged to retain a 2 dimensional appearance for this portion of the 3D-appearing pipe segment. Also, a pipe element may be extended (712), for example, by selecting and dragging a start, end, or vertex handle of the pipe element on the canvas. Further, the operation 700 may draw a bend in the pipe element (714), such as a right-angle bend or an unconstrained bend, for example, by dragging a start handle or an end handle of the pipe element. In addition, the operation 700 may adjust a pipe section of a pipe element (716). In particular, a section of a pipe element may be lengthened or shortened by dragging a vertex handle of the section. The operation 700 may also draw a branch of a pipe element (718), for example, by dragging a midpoint handle. Also, a branch or connection handle may be moved along a pipe segment, or an entire branch segment may be moved, (720) as long as it is not merged with another pipe segment.

The operation 700 may draw a pipe coupling (722), for example, by selecting a pipe coupling element and selecting start and end points of a straight pipe segment. For some embodiments, the pipe coupling joints may be displayed automatically as a segment is drawn. Also, a pipe coupling may be overlayed onto a pipe element (724). The operation 700 may further generate and/or modify components of the HVAC piping graphic multiple times, as needed or desire for each BAS.

For some embodiments, in response to generating and modifying various components of the HVAC piping graphic, the operation 700 of the piping graphic editor or module may add symbols to the HVAC piping graphic to some or all of the components, including the pipe elements and the pipe coupling elements (728). For some embodiments, the symbol match may display automatically in the view of the user interface as graphics/text are entered or selected.

The piping graphic editor or module of the management device 104, 106, 108 may finalize a HVAC piping graphic or diagram, in which the wireframe or background layer may be removed from visibility so that it will not display in operating mode (730). The operation 700 of the piping graphic editor or module may include other functions not shown in FIG. 8. For example, pipe elements may be drawn (straight), selected, copied, or deleted from a canvas, and a segment may be disconnected from a branch or connection handle. For other example, pipe elements or segments may be merged from a start, end, or midpoint handle, and pipe and pipe coupling elements may be bound together so that they do not separate during further engineering of a graphic.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A system with piping graphic control for building automation comprising:
a field device of the building automation to manage an HVAC device of an environmental system; and
a management device communicating with a plurality of field devices associated with a plurality of HVAC equipment including the field device of the building automation, the management device comprising:
a user interface to receive a user input and provide data points of the building automation system based on the a pipe element and a pipe coupling element; and
a processor to identify the plurality of field devices, generate an HVAC piping graphic associated with the plurality of field devices, modify the HVAC piping graphic based on the least one user input by integrating a pipe element and a pipe coupling element coupled to the pipe element with the HVAC piping graphic based on the user input,
wherein the management device monitors runtime values and dynamically controls the building automation system based on the data points of the building automation system.

2. The system as described in claim 1, wherein the processor creates a background layer to guide pipe drawings, creates a piping layer that distinguishes hot water pipe elements from cold water pipe elements, and configures graphic properties of a canvas for the HVAC piping graphic.

3. The system as described in claim 1, wherein:
each pipe element includes a plurality of handles;
the user input received at the user interface includes an adjustment of at least one handle of the plurality of handles; and
the processor modifies the HVAC piping graphic based on the adjustment of the handle of the plurality of handles.

4. The system as described in claim 1, wherein the user interface provides the data points of the building automation system via properties of the pipe element and the pipe coupling element at the user interface.

5. The system as described in claim 4, wherein the properties including a fitting type to identify a type of elbow bend for a pipe element and an auto pipe joint property to automatically provide a pipe joint on the pipe element.

6. The system as described in claim 1, wherein:
the management device associates device/equipment symbols representing the plurality of field devices on the HVAC piping graphic; and
the management device monitors the runtime values and dynamically controls the plurality of field devices based on the device/equipment symbols.

7. The system as described in claim 1, wherein the management device manages at least one performance feature of the plurality of field devices based on the modified HVAC piping graphic.

8. A method for a building automation system with piping graphic control comprising:
identifying a plurality of field devices associated with a plurality of HVAC equipment corresponding to the plurality of field devices at a management device of the building automation system;
generating an HVAC piping graphic associated with the plurality of field devices at the management device;
receiving a user input at a user interface of the management device;
modifying the HVAC piping graphic at a processor of the management device in response to receiving the user input, modifying the HVAC piping graphic including integrating a pipe element and a pipe coupling element coupled to the pipe element with the HVAC piping graphic based on the user input; and
providing data points of the building automation system at the user interface based on the pipe element and the pipe coupling element; and
monitoring runtime values and dynamically controlling the building automation system at the management device based on the data points of the building automation system.

9. The method as described in claim 8, wherein generating the HVAC piping graphic comprises:
creating a background layer to guide pipe drawings;
creating a piping layer that distinguishes hot water pipe elements from cold water pipe elements; and
configuring graphic properties of a canvas for the HVAC piping graphic.

10. The method as described in claim 8, wherein:
each pipe element includes a plurality of handles;
the user input received at the user interface includes an adjustment of at least one handle of the plurality of handles; and
the processor modifies the HVAC piping graphic based on the adjustment of the handle of the plurality of handles.

11. The method as described in claim 8, wherein providing the data points of the building automation system includes providing the data points of the building automation system via properties of the pipe element and the pipe coupling element at the user interface.

12. The method as described in claim 12, wherein the properties including a fitting type to identify a type of elbow bend for a pipe element and an auto pipe joint property to automatically provide a pipe joint on the pipe element.

13. The method as described in claim 8, wherein monitoring the runtime values and dynamically controlling the building automation system comprises:
associating device/equipment symbols representing the plurality of field devices on the HVAC piping graphic; and
monitoring the runtime values and dynamically controlling the plurality of field devices based on the device/equipment symbols.

14. The method as described in claim 8, wherein monitoring runtime values and dynamically controlling the building automation system includes managing at least one performance feature of the plurality of field devices based on the modified HVAC piping graphic.

15. A non-transitory computer readable medium including executable instructions which, when executed, causes at least one processor to provide piping graphic control for a building automation system by:
identifying a plurality of field devices associated with a plurality of HVAC equipment corresponding to the plurality of field devices at a management device of the building automation system;
generating an HVAC piping graphic associated with the plurality of field devices;
receiving a user input;
modifying the HVAC piping graphic in response to receiving the user input, modifying the HVAC piping graphic including integrating a pipe element and a pipe coupling element coupled to the pipe element with the HVAC piping graphic based on the user input; and
providing data points of the building automation system based on the pipe element and the pipe coupling element; and
monitoring runtime values and dynamically controlling the building automation system based on the data points of the building automation system.

16. The medium as described in claim 15, wherein:
each pipe element includes a plurality of handles;
the user input received at the user interface includes an adjustment of at least one handle of the plurality of handles; and
the processor modifies the HVAC piping graphic based on the adjustment of the handle of the plurality of handles.

17. The medium as described in claim 15, wherein providing the data points of the building automation system includes providing the data points of the building automation system via properties of the pipe element and the pipe coupling element at the user interface.

18. The medium as described in claim 17, wherein the properties including a fitting type to identify a type of elbow bend for a pipe element and an auto pipe joint property to automatically provide a pipe joint on the pipe element.

19. The medium as described in claim 15, wherein monitoring the runtime values and dynamically controlling the building automation system comprises:
associating device/equipment symbols representing the plurality of field devices on the HVAC piping graphic; and
monitoring the runtime values and dynamically controlling the plurality of field devices based on the device/equipment symbols.

20. The medium as described in claim 15, wherein modifying the HVAC piping graphic comprises at least one of:
changing a pipe element;
changing a pipe coupling element;
adjusting the pipe element and the pipe coupling element relative to each other; or
removing the pipe element or the pipe coupling element.
